(19) United States
(12) Patent Application Publication
(10) Pub. No.: US 2014/0044914 A1
(43) Pub. Date: Feb. 13, 2014

(54) SELF-STIFFENED COMPOSITE PANEL PARTICULARLY FOR AIRCRAFT FLOORS AND METHOD FOR MANUFACTURING THE SAME

(71) Applicants: Didier Kurtz, Pornic (FR); Marion Besnard, Saint Julien De Chedon (FR); Jacques Marterer, Garches (FR)

(72) Inventors: Didier Kurtz, Pornic (FR); Marion Besnard, Saint Julien De Chedon (FR); Jacques Marterer, Garches (FR)

(21) Appl. No.: 14/112,241

(22) PCT Filed: May 2, 2012
(86) PCT No.: PCT/EP2012/057987

§ 371 Date: Oct. 18, 2013

(30) Foreign Application Priority Data
May 2, 2011 (FR) 1101351

(51) Int. Cl. B64C 1/18; B32B 38/00

(52) U.S. Cl. CPC B64C 1/18; B32B 38/0012
USPC 428/74; 156/210; 428/182

(57) ABSTRACT

A panel for an aircraft floor comprising a first plate made of composite material with continuous fiber reinforcement. A corrugated sheet made of composite material with continuous fiber reinforcement is joined to one side, the underside, of the first plate. A local reinforcing means is joined to the corrugated sheet.

The invention relates to a self-stiffened composite panel, particularly intended for making up a floor, more particularly but not exclusively for an aircraft floor. The panel according to the invention advantageously makes it possible to make a floor that is lighter than one made using the known solutions of the prior art.

According to the prior art, a floor, particularly an aircraft floor, is made up of a support structure and flooring. The support structure is made up of beams and the flooring is made up of plates or strips fitted to those beams so as to form a substantially flat surface. For example, in the case of an aircraft, the support structure is made up of beams arranged transversally, or cross beams, connected to the fuselage of said aircraft and making up joisting. Longitudinal rails are fixed to such cross beams and comprise a fastening interface for the connection of movable elements contained in the fuselage, particularly passenger seats and system furniture or monuments. The rails also comprise a fitting interface that makes it possible to fit floor unit plates between said rails in order to make up the flooring. According to other construction principles, the support structure is made up of a grid comprising beams that extend in a transverse or longitudinal direction and other beams mounted as braces between them, so as to form a grid. The floor unit plates are then fitted on the grid and fastened to the beams. In one embodiment widespread in the aeronautic area, these floor unit plates or flooring panels are made up of a sandwich comprising a honeycomb structure held between two plates or skins. Such floor panels have for example been described in the document U.S. Pat. No. 7,581,366. Said floor panels carry the stresses applied on the floor towards the structure of the fuselage through the support structure. These stresses are made up of loads: moving passengers, movable equipment such as carts in passenger aircraft, rolling loads or handling equipment in cargo aircraft and also cabin pressure.

Sandwich floor panels with honeycomb cores offer exceptional rigidity in compression and bending. However, such bending rigidity is essentially the result of the spacing of the skins by the thickness of the honeycomb core, which core only makes a small contribution to the bending strength. Thus, these panels are particularly lightweight, as bending rigidity is achieved by small skin thicknesses. On the other hand, these skins, if they are made up of composite material with an organic matrix and fiber reinforcement, have very low peening resistance, particularly at the points where the floor panels are fastened to the support structure. That makes it necessary to make particular arrangements, commonly called hard points, which particularly consist in filling the cells of the core with resin at the points where the panel is fastened to the rails. These hard points create breaks in the flow of stresses towards the structure of the fuselage and add to the mass. Similarly, local penetration resistance of such a floor panel is not achieved by the thickness of the skin that would be exactly necessary for handling the bending stresses. Finally, the mechanical strength of these panels is highly influenced by the quality of the mechanical coupling between the two skins, which depends on the quality of the bonding between said skins and the core, as the bending stresses are transmitted from one skin to another by shear stresses of the interface between the skin and the core. The quality of bonding required is difficult to achieve in view of the very small contact area between the edges of the cells of the core and the skins. Very great care must therefore be taken while preparing the core and the skins, particularly in terms of the evenness of the interfaces, and while determining the gluing conditions. That requirement relating to the manufacturing quality for achieving the full performance of sandwich panels generates high manufacturing costs or leads to oversizing that has an adverse effect on the mass of the floor.

The document WO 2008/157075 describes a composite structural panel that is particularly intended for making aircraft floors, which panel is the result of an assembly of stiffeners in the form of sections that are interwoven by tape laying, then cured simultaneously with a skin that thus surrounds the stiffeners. The making of such a panel is complex and is essentially justified in integral floor panels, where a single panel covers almost the totality of the flooring of the aircraft. That technical solution is thus only advantageous with small aircraft.

The invention aims to remedy the drawbacks of prior art and discloses a panel, particularly for an aircraft floor, which panels comprises:
a. a first plate made of a composite material with continuous fiber reinforcement;
b. a corrugated sheet made of a composite material with continuous fiber reinforcement joined to one side, called the underside, of the first plate;
c. a local reinforcing means joined to the corrugated sheet.

Thus, the corrugated sheet and the plate cooperate to give the panel bending rigidity, as the plate is sufficiently thick to withstand penetration, and the reinforcing means locally provides peening resistance, particularly in fastening areas.

Mechanical coupling between the plate and the corrugated sheet is achieved by large contact surfaces and the reinforcing means cooperates with that interface to spread the stresses between the plate and the corrugated sheet.

The invention can be implemented according to the advantageous embodiments described below, which may be considered individually or in any technically operative combination.

According to a first embodiment of the panel according to the invention, the local reinforcing means is made up of an insert placed in the space between the underside of the first plate and the internal walls of a relief feature of the corrugated sheet. Thus, said inserts are only placed at the locations where they are necessary, particularly at the points where the panel is fixed to the support structure. The corrugated sheet can cover the totality of the surface of the plate.

According to a second embodiment of the panel according to the invention, the local reinforcing means comprises a plate made of a composite material with continuous fiber reinforcement. In this embodiment, the part of the corrugated sheet comprising corrugations cannot cover the area covered by the reinforcing plate. However, that same reinforcing plate allows mechanical coupling over a larger area and better transfer of the loads between the plate and the corrugated sheet.

These two embodiments may be combined in the same panel.

According to one advantageous mode of carrying out the second embodiment of the panel according to the invention, the corrugation relief features of the corrugated sheet are interrupted beyond a perimeter, called the fitting perimeter, located within the edges of the first plate. Thus, the panel comprises on its perimeter a zone that is free of corrugations, which reduces its height on the floor support structure.

Advantageously, according to that same embodiment, the thickness of the panel is constant in the space located between the edge of the first plate and the fitting perimeter. That characteristic makes it easier to fit and set the panel on the support structure.

Advantageously, the reinforcing means is then placed between the fitting perimeter and the edge of the first plate.

Regardless of the embodiment, the plate, the corrugated sheet and the reinforcing means are made of materials comprising a thermoplastic matrix. Thus, the assembly can be assembled effectively, particularly by welding. These materials further offer heightened resistance to impacts and peening compared to the thermosetting resins that are commonly used for such applications, which properties are advantageous in respect of sizing.

Advantageously, the plate, the corrugated sheet and the reinforcing means are made of materials comprising a polyetheretherketone matrix. That constitution further gives it excellent fire and temperature resistance, which properties are particularly sought in aeronautic applications.

According to an advantageous characteristic of the first embodiment of the panel of the invention, the panel comprises a closing frame on the perimeter of said panel. That closing frame stops the penetration of humidity in the hollow spaces between the underside of the plate and the inner walls of the relief features of the corrugated sheet.

The panel according to the invention can be adapted for covering lattice support structures of all types, flat or in more complex shapes, as the panel according to the invention can be shaped before or after the plate and corrugated sheet are assembled.

More particularly, the invention also relates to a floor, particularly for aircraft, which floor comprises a support structure and a panel according to any of the previous embodiments that is fixed to said support structure. The mass and manufacturing costs of such a floor are lower compared to the known solutions of the prior art. The panel according to the invention may be used to cover all or part of the surface of the floor. For example, in the case of an aircraft, floor panels according to the prior art, of the sandwich type, may be used in the parts located under the seats of passengers, and panels according to one of the embodiments of the invention may be used in the areas supporting larger loads, such as in the areas supporting the movement of carts.

According to a first embodiment, said floor comprises a panel according to the second embodiment of the panel according to the invention, which panel is fixed to the support structure in the zone located between the fitting perimeter and the edge of the first plate. This embodiment makes it possible to reduce the height of the floor and therefore increases the interior space of the volume demarcated by said floor.

According to a second embodiment, said floor comprises a panel according to the first embodiment of the panel of the invention that is fixed to the support structure by fasteners that go through the inserts. This embodiment is more particularly suitable for the replacement of a floor panel according to the prior art by a floor panel according to the invention

The invention also relates to an aircraft comprising a floor according to one of the previous embodiments. The floor area in an aircraft can reach several hundreds of square meters. Thus the mass reduction afforded by each panel according to the invention allow, when added together, a considerable reduction that has a favorable effect on the fuel consumption of said aircraft.

The invention finally relates to a particularly economical method for manufacturing a panel of the invention according to its embodiments using elements made of materials comprising a thermoplastic matrix, which method comprises the steps of:

i. hot stamping a pre-consolidated plate to make the corrugated sheet;

ii. welding the corrugated sheet to the first plate;

iii. assembling the reinforcing means with the assembly thus made.

The use of hot stamping makes it possible to make the corrugated sheet from a plate with continuous fiber reinforcement using a manufacturing mode that is suitable for mass production. The use of welding allows excellent bonding of the assembly interface between the corrugated sheet and the first plate.

Advantageously, the welding step is carried out by hot pressing the entire corrugated sheet, after inserting extractible cores between the corrugated sheet and the first plate inside the relief features of said corrugated sheet. In that way, welding can be carried out in a single operation.

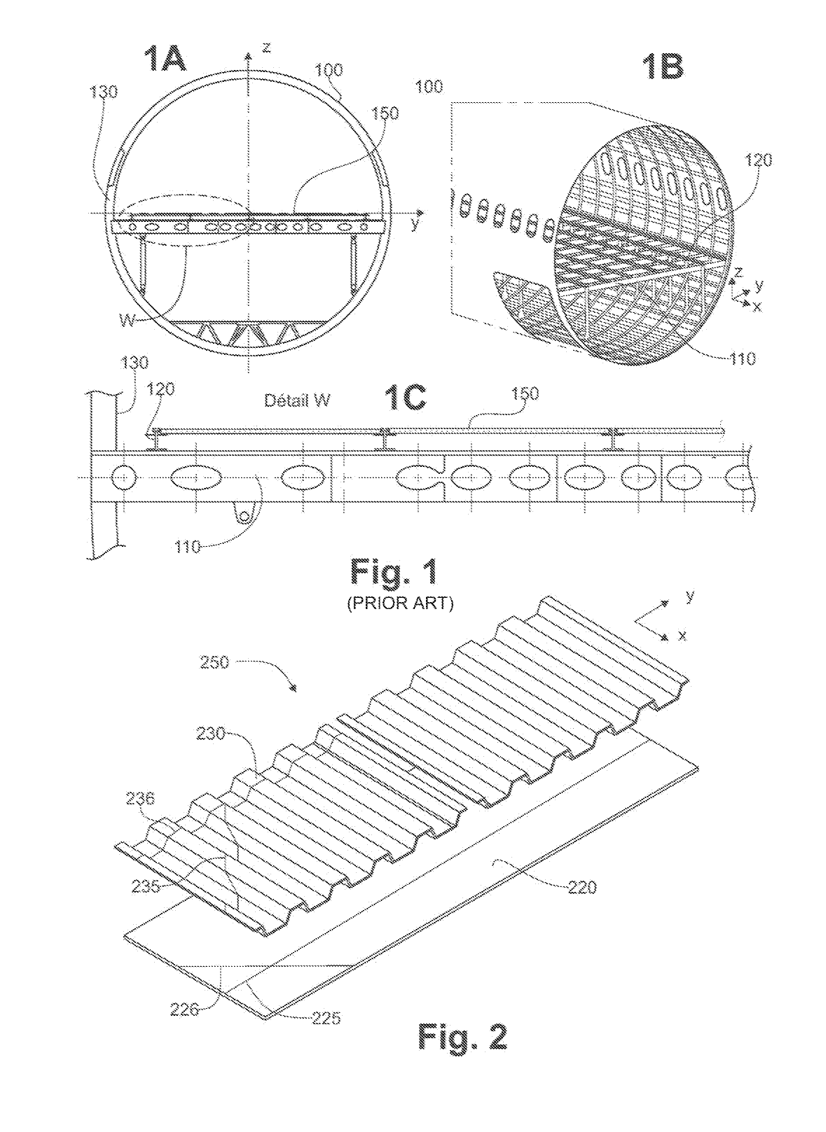

The invention is described below in its preferred embodiments, which are not limitative in any way, and by reference to FIGS. 1 to 10, wherein:

FIG. 1 relates to the prior art; FIG. 1A is a cross section of an aircraft fuselage, FIG. 1B, is a perspective view from the end of a fuselage section and FIG. 1C is a detailed view of the cross section of the installation of a floor in said fuselage;

FIG. 2 represents a perspective top view of two of the elements of the panel according to the invention, namely the first plate and the corrugated sheet added to that plate;

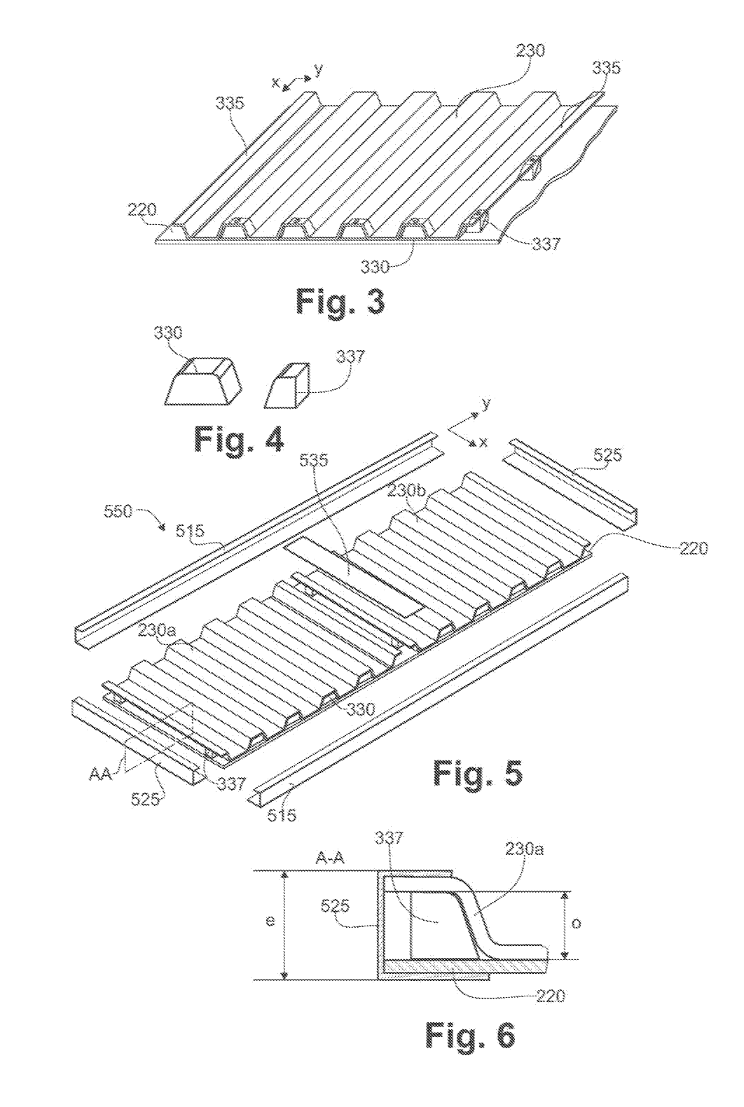

FIG. 3 is a perspective front view along a longitudinal end of a panel according to one exemplary embodiment corresponding to the first embodiment of the invention;

FIG. 4 is a perspective front view of exemplary embodiments of inserts adapted as local reinforcing means for a panel according to the first embodiment of the invention;

FIG. 5 is an exploded view of the assembly of a panel according to an example of the first embodiment of the invention;

FIG. 6 is a sectional view along the plane AA defined in FIG. 5 of the transverse end of a panel according to an example of the first embodiment of the invention;

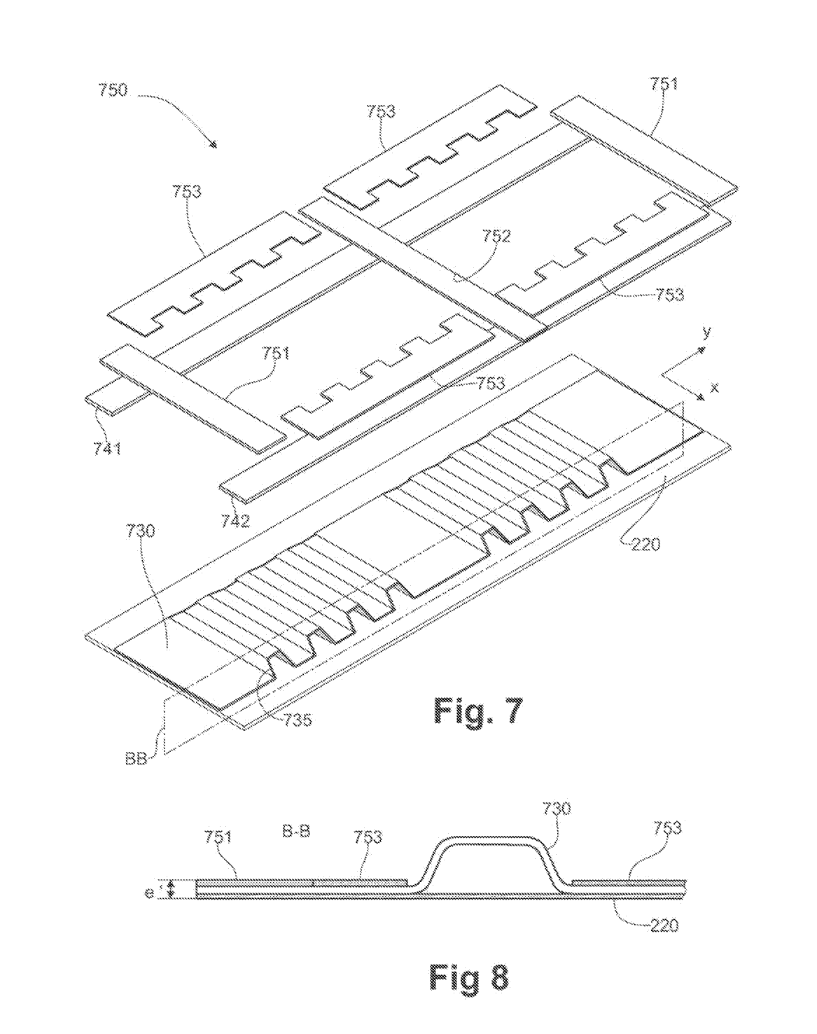

FIG. 7 is a perspective exploded view of the assembly of a panel according to an example of the second embodiment of the invention;

FIG. 8 is a sectional view along the plane BB defined in FIG. 7 of the transverse end of a panel according to an example of the second embodiment of the invention;

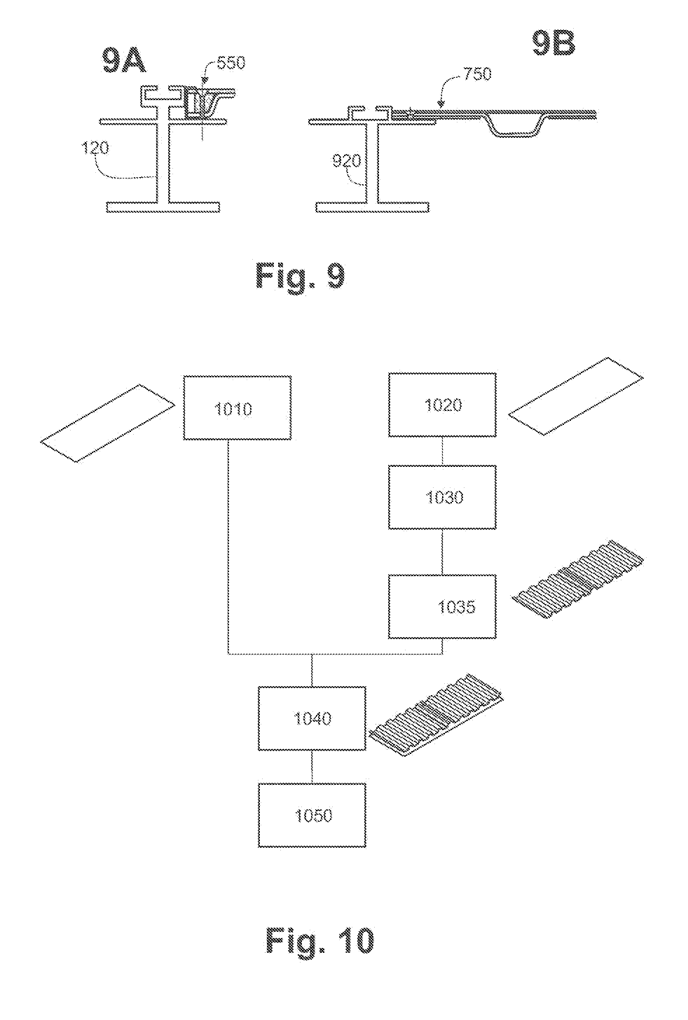

FIG. 9 relates to a sectional view of two examples of the assembly of panels according to exemplary embodiments of the invention on a support structure of a floor; FIG. 9A shows the first embodiment of the invention and FIG. 9B shows the second embodiment of the invention;

and FIG. 10 represents a flow chart of an exemplary embodiment of the method according to the invention.

In all the figures, the transverse direction is shown by ‘y’ and the longitudinal direction is shown by ‘x’. In the exemplary embodiment shown in FIG. 1, the longitudinal and transverse axes are the longitudinal and transverse axes of the fuselage; that example is not limitative in any way and the person skilled in the art can adapt the direction of the panel according to the loads to which the panel will be subjected in service so as to obtain the required rigidity.

FIG. 1B shows an exemplary embodiment of a floor for an aircraft, which comprises a support structure, comprising cross beams (110) that extend transversally in the fuselage (100) of said aircraft. Rails (120) are placed on the cross beams (110) and extend longitudinally in the fuselage (100). In FIG. 1A, the cross beams (110) are fixed to the frames (130) that make up the framework of the fuselage. In FIG. 1C, the floor panels (150) are fitted on the rails (120) and make up the flooring. Thus, the floor panels carry the stresses applied on the flooring to the fuselage (100) through the rails (120) and the cross beams (110). Said floor panels (150) are subjected to bending stress by bending moments parallel to the longitudinal (x) and transverse (y) axes that tend to deform said floor panels by bending them along the vertical axis (z). According to the prior art, the floor panels (150) are made up of sandwich panels comprising two skins separated by a honeycomb core.

In FIG. 2 according to an exemplary embodiment of the floor panel according to the invention, the floor panel comprises a plate (220) made of a composite material with continuous fibers (225, 226) reinforcement, that is to say that said fibers extend from one end of said plate (220) to the other. The panel is rigidified with regard to bending stresses by the addition of a corrugated sheet (230) also made of a composite material with continuous fibers (235, 236) reinforcement. Said corrugated sheet (230) is added to the plate by gluing, welding or simultaneous curing depending on the nature of the material used. The corrugated sheet (230) comprises alternating corrugations extending in a transverse section on each side of a median plane along a corrugation profile that is substantially in the form of an Ω (the Greek letter omega), which profile creates longitudinally extending stiffeners once the corrugated sheet (230) is added to the plate (220). According to an advantageous exemplary embodiment, the plate (220) and the corrugated sheet (230) are made of a composite laminate made from unidirectional APC-2/AS4 plies comprising 66% carbon fibers that are pre-impregnated with thermoplastic polyetheretherketone or PEEK resin. The plate (220) comprises 6 plies, directed according to the sequence 0/90/45/-45/90/0 and its thickness after compacting is 0.828 mm. The corrugated sheet (230) is made of the same material and a stack of 8 plies according to the sequence 0/90/-45/45/-45/45/90/0 that is 1.1 mm thick after compacting. The 0° direction is the transverse direction (y). The material has high rigidity and high mechanical resistance in view of its fiber content. Besides, PEEK resin is particularly resistant to impacts and its fire resistance is suitable for the most demanding applications, particularly aeronautics applications.

In FIG. 3 of a first embodiment of a floor panel according to the invention, the corrugated sheet (230) covers the totality of the surface of the plate (220). To make said panel easier to fit, the corrugated sheet (230) ends at the transverse ends of the panel in half-corrugations (335) that are raised in relation to the plate (220). The floor panel made in that way rests on, and is fixed to, the support structure by its edges. In view of the half-corrugation profile (335) ending the transverse ends of the corrugated sheet (230) its thickness is constant over its entire perimeter. In order to allow such fastening, inserts (330, 337) are placed between the plate (220) and the corrugated sheet (230) inside the corrugation profiles in the zones receiving fasteners. The holes for receiving the fasteners are then made in these inserts.

In FIG. 4, two types of insert are used. Full inserts (330) are substantially trapezoidal in section, complementary to the interior shape of a corrugation profile of the corrugated sheet. Half inserts (337) are integrated into the transverse ends of the panel in the half-corrugation profiles (335) of the corrugated sheet. The inserts (330, 337) are advantageously joined to the panel by welding, gluing or simultaneous curing depending on the materials used. In the previous exemplary embodiment, where the floor panel is made up of a PEEK APC-2/AS4 composite, said inserts (300, 337) are advantageously made of polyetheretherketone resin with short reinforcing fibers and are made by injection or extrusion.

In FIG. 5, in one exemplary embodiment of a floor panel (550) according to the first embodiment of the invention, two corrugated sheets (230a, 230b) juxtaposed transversally are assembled with a plate (220). Thus, at the transverse half of said panel, two half-corrugation ends of said corrugated sheets (230a, 230b) are placed opposite each other. Advantageously, the floor panel is fixed on the rails of the support structure or a grid support structure over the entire perimeter and in that central zone. After assembling the inserts (330) in the corrugation profiles at the longitudinal ends of the panel and the half inserts at the transverse ends of the corrugated sheets (230a, 230b), closing profiles (515, 525) are glued over the entire perimeter of the panel, making up a closing frame. Closing profiles (535) are also glued to its central part. The closing profiles (515) for the longitudinal ends and the closing profiles (525) for the transverse ends have a section that is substantially U shaped and extend over the entire length of the end of the panel. The closing profile (535) of the central part is a simple sheet that covers the space between the ends of the two corrugated sheets (230a, 230b). In one exemplary embodiment, these closing profiles (515, 525, 535) are made of a composite comprising a polyetheretherketone matrix reinforced by two plies of glass fibers, with a 0.4 mm thickness. These closing profiles complete the closing of the corrugation profiles, already achieved in part by the inserts (330), particularly at the transverse ends of the floor panel. Thus, they prevent humidity, particularly condensation, or fluids entering these corrugation profiles and leading to an increase in mass.

FIG. 6, advantageously, the corrugation height (o) is determined by rigidity constraints and also so that the thickness of the finished panel is substantially equivalent to that of a panel with a honeycomb core according to the prior art. Thus, the floor panel according to the invention can easily be fitted to replace a floor panel according to the prior art.

FIG. 7, in a second embodiment of a floor panel (750) according to the invention, the floor panel comprises a first plate (220) to which the corrugated sheet (730) is added, and the corrugated sheet covers the entire transverse surface of the plate but only part of it in the longitudinal direction. Said corrugated sheet (730) does not comprise corrugations over a width at its transverse ends, and possibly in its central part. Two strips (741, 742) are assembled with the plate (220) on the zones at the longitudinal ends that are not covered by the corrugated sheet (730). Advantageously, the thickness of these strips (741, 742) is equivalent to the thickness of the corrugated sheet. Thus, at the surface of the panel, there is a perimeter, called the fitting perimeter, such that no corrugation relief feature is present between that perimeter and the edges of the panel. After the strips (741, 742) are assembled, the thickness of the panel is constant beyond that perimeter, which thus makes up a fitting plane. Advantageously, the ends (735) of the corrugation profiles of the corrugated sheet (730) are trimmed with a bevel so that they do not hinder the installation of the panel on the support structure. Reinforcing means (751, 752, 753) in the form of trimmed plates are assembled by gluing, welding or simultaneous curing with the panel on the fitting zone between the fitting perimeter and the edges of said panel. In one exemplary embodiment, said reinforcing means comprise two end plates (751) placed at the transverse ends of the panel, a central plate (752) extending in the central zone where the corrugated sheet (730) has no corrugations and four finger plates (753) that are placed on the longitudinal ends of the panel between the end plates (751) and the central plate (752). The finger plates (753) are trimmed with a slotted profile, where each slot surrounds one end of a raised corrugation profile of the corrugation sheet (730).

Thus, they effectively transfer the transverse bending moments from the fitting zones at the longitudinal ends to the corrugated sheet (730). In one exemplary embodiment, the strips (741, 742) are made of PEEK APC-2/AS4 composite comprising 8 plies, and the reinforcing means are made from a PEEK APC-2/AS4 plate comprising 6 plies.

In FIG. 8, the fitting zone is flat and has a constant thickness. In the previous exemplary embodiment, that fitting zone comprises a total stack of 20 plies with a total thickness (e′) of 2.75 mm.

In FIG. 9, while the first embodiment of the floor panel (550) according to the invention can be used advantageously to replace the panels of the prior art while retaining the rails (120) of the existing support structure, the second embodiment of the panel (750) according to the invitation makes it possible, because of the low height of the fitting interface, to use low rails (920) and thus reduce the mass of said rails.

In FIG. 10, according to an exemplary embodiment of the method for manufacturing the panel in the invention, said method comprises two first steps for preparing and trimming consolidated composite plates. A preparation step (1010) is intended for making the first plate (220). Another preparation step (1020) carried out in parallel with the first one consists in making and trimming a consolidated plate intended for making the corrugated sheet (230, 730). The plates are preferably made by tape laying and consolidating carbon fiber plies impregnated with a thermoplastic resin such as polyetheretherketone. During a stamping step (1030) the plate obtained during the previous step (1020) is formed by stamping between a punch and a die after said plate is heated to a temperature close to the fusion temperature of the thermoplastic resin. At that resin fusion temperature, the continuous reinforcing fibers can slip in relation to each other, to obtain the required shape. Regardless of the embodiment considered, the profile of the corrugated sheet is developable. Thus stamping does not pose any particular difficulty providing uniform temperature is applied over the entire surface of the blank. Alternatively, the corrugated sheet may also be made by tape laying and consolidation to the finished dimension. After stamping, an intermediate step (1035) consists in trimming the corrugated sheet so as to remove its insufficiently compacted edges, on which the relative slipping of the plies is visible. During that same intermediate step (1035), the ends (735) of the corrugation profiles are also trimmed. Such trimming is carried out by means of a high-pressure abrasive water jet or a cutting tool. During an assembly step (1040), the first plate and the corrugated sheet are assembled. If these two elements are made of a composite with a thermoplastic matrix, the assembly is advantageously made by welding. Welding is achieved by heating the plate and corrugated sheet to a temperature close to the fusion temperature of the resin and applying pressure that urges them against each other. That operation may be carried out in an autoclave or with a self-standing tooling. Extractible cores are advantageously inserted inside the corrugation profiles of the corrugated sheet so that the profiles do not collapse under the applied pressure. Alternatively, welding may be achieved by continuous welding means consisting in locally heating the assembled zones by an appropriate temperature generator such as a laser, a sonotrode, a resistance or an inductor, and moving said generator along appropriate welding lines. That continuous welding assembly mode is more flexible but less productive than the previous one. After assembling the first plate and the corrugated sheet, the reinforcing means are assembled during a finishing step (1050) according to the methods described above. Advantageously, the closing profiles are integrated into the finishing step, depending on the embodiment. The panel can then be completed by making holes adapted for fixing it to the support structure, finally trimming and deburring it to bring it to the exact dimensions, or cleaning it to facilitate bonding of the coating on said panel. Thus, the making of the panel according to the invention relies on an original combination of proven methods where quality assurance relies on application parameters that can be easily measured during the process. In particular, the assembly method using pressure and welding guarantees the bonding of the assembly and the effective mechanical coupling between the first plate and the corrugated sheet that makes it rigid, including with a large adhesion surface between the corrugated sheet and said first plate.

According to the prior art, the weight of a floor panel with a honeycomb core in aluminium alloy offered commercially by TEKLAM Corp., 1121 Olympic Corona, Calif. 92881, USA, is approximately 4.42 kg·m⁻² for thickness of 10 mm (0.4″). For that same thickness, a floor panel with a honeycomb core in NOMEX® has a surface density of 3.8 kg·m⁻². A floor panel according to the invention has a surface density of 3.65 kg·m⁻² with mechanical and usage characteristics that are at least equivalent.

The description above and the exemplary embodiments show that the invention achieves its objectives; in particular, it makes it possible to make self-stiffened panels that are particularly adapted for making aircraft floors and are lighter and more economical than the known panels of the prior art for similar applications.

1. A panel for an aircraft floor, comprising:
a first plate made of a composite material with continuous fibers reinforcement;
a corrugated sheet made of composite material with continuous fibers reinforcement joined to one side or an underside of the first plate; and
a local reinforcing member joined to the corrugated sheet.

2. The panel according to claim 1, wherein the local reinforcing member is made up of an insert placed in the space between the underside of the first plate and internal walls of a relief feature of the corrugated sheet.

3. The panel according to claim 1, wherein the local reinforcing member comprises a plate made of a composite material with continuous fibers reinforcement.

4. The panel according to claim 3, wherein corrugation relief features of the corrugated sheet are interrupted beyond a fitting perimeter located within edges of the first plate.

5. The panel according to claim 4, wherein the thickness of the panel is constant in the space located between an edge of the first plate and the fitting perimeter.

6. The panel according to claim 5, wherein the reinforcing member is placed between the fitting perimeter and the edge of the first plate.

7. The panel according to claim 1, wherein the plate, the corrugated sheet and the reinforcing member are made of materials comprising a thermoplastic matrix.

8. The panel according to claim 7, wherein the plate, the corrugated sheet and the reinforcing member are made of materials comprising a polyetheretherketone matrix.

9. The panel according to claim 2, further comprising a frame made of closing profiles on a perimeter of said panel.

10. A floor for an aircraft, comprising a support structure and the panel according to claim 1, that is fixed to said support structure.

11. The floor according to claim 10 wherein the local reinforcing member comprises a plate made of a composite material with continuous fibers reinforcement;
wherein the corrugation relief features of the corrugated sheet are interrupted beyond a fitting perimeter located within edges of the first plate;
wherein the thickness of the panel is constant in the space located between an edge of the first plate and the fitting perimeter;
wherein the reinforcing member is placed between the fitting perimeter and the edge of the first plate; and
wherein the panel is fixed to the support structure in a zone located between the fitting perimeter and the edge of the first plate.

12. The floor according to claim 10, wherein the local reinforcing member is made up of an insert placed in the space between the underside of the first plate and internal walls of a relief feature of the corrugated sheet; and further comprising a frame made of closing profiles on a perimeter of said panel; and wherein said panel is fixed to the support structure by fasteners that go through the insert.

13. An aircraft comprising a floor according to claim 10.

14. A method for manufacturing a panel comprising a first plate, a corrugated sheet, and a local reinforcing member, each made of materials comprising a thermoplastic matrix, the method comprising the steps of:
hot stamping a pre-consolidated plate to make the corrugated sheet made of composite material with continuous fibers reinforcement joined to one side or an underside of the first plate;
welding the corrugated sheet to the first plate made of a composite material with continuous fibers reinforcement; and
assembling the reinforcing member joined to the corrugated sheet with an assembly thus made.

15. The method according to claim 14, wherein the welding step comprises the step of hot pressing the entire corrugated sheet, after inserting extractible cores between the corrugated sheet and the first plate inside relief features of said corrugated sheet.
